(19) United States
(12) Patent Application Publication
(10) Pub. No.: US 2021/0286765 A1
(43) Pub. Date: Sep. 16, 2021

(54) COMPUTER SYSTEM, FILE STORAGE AND DATA TRANSFER METHOD

(71) Applicant: Hitachi, Ltd., Tokyo (JP)

(72) Inventors: Masanori TAKATA, Tokyo (JP); Shimpei NOMURA, Tokyo (JP); Mitsuo HAYASAKA, Tokyo (JP)

(73) Assignee: Hitachi, Ltd.

(21) Appl. No.: 17/004,909

(22) Filed: Aug. 27, 2020

(30) Foreign Application Priority Data
Mar. 10, 2020 (JP) 2020-040747

(51) Int. Cl. G06F 16/178; G06F 16/18

(52) U.S. Cl. CPC G06F 16/178; G06F 16/1865

(57) ABSTRACT

To reduce the data transfer amount required for a byte-level transfer of difference data, and avoid increases of management data and in the number of sessions at the time of a byte-level transfer of differences.

In a computer system including: a first file storage that has a file system; a second file storage that receives an object request from the first file storage; and an object storage that stores a file or a directory that has been transferred to the object storage as an object, the first file storage detects an updated file or a directory of the file system from a client when the file system is updated; aggregates, collectively into a difference aggregation object, a plurality of pieces of difference data and difference data update information of detected files or directories; and transfers the difference aggregation object to the second file storage.

### BACKGROUND OF THE INVENTION

### 1. Field of the Invention

The present invention relates to a technology for transferring data between a plurality of file storage apparatuses.

### 2. Description of the Related Art

There is a known computer system that realizes data transfer between storage apparatuses each installed at a different site, and connected to an object storage apparatus.

For example, PCT Patent Publication No. WO2018/154698 discloses a technology of dividing file data into chunks having fixed lengths at a file storage apparatus, and transferring updated chunks from a client to an object storage apparatus by using Multi-part Upload API.

In addition, U.S. Pat. No. 9,720,777 discloses a technology of dividing file data into chunks at a file storage apparatus, and storing updated chunks, each as a single object, from a client in an object storage apparatus. Because the file data includes a plurality of objects, the set of {Offset, Length and Object address} is retained at the file storage apparatus for each chunk.

However, according to the technologies disclosed in PCT Patent Publication No. WO2018/154698 and U.S. Pat. No. 9,720,777, since transfer from a file storage apparatus to an object storage apparatus is performed in the chunk unit of several MBs, even an update of one byte of data requires transfer of several MBs of data. Accordingly, the time required for the transfer increases.

In addition, according to the technology disclosed in U.S. Pat. No. 9,720,777, if the chunk size is made smaller, the set of information for managing each chunk {Offset, Length and Object address} increases. Accordingly, information managed at file storage apparatuses increases, and the capacity efficiency deteriorates. Furthermore, the recall performance deteriorates due to session establishment in small units because one file is stored as a plurality of divided objects.

Accordingly, there are problems in terms of reduction in the data transfer amount required for a byte-level transfer of difference data, and avoidance of increases of management data and in the number of sessions at the time of a byte-level transfer of differences.

An object of the present invention is to provide a computer system, a file storage and a data transfer method that make it possible to reduce the amount of data transfer between each site and a data center.

### SUMMARY OF THE INVENTION

In order to overcome the problems, a computer system according to the present invention has: a first file storage that has a file system; a second file storage that receives an object request from the first file storage; and an object storage that stores a file or a directory that has been transferred to the object storage as an object. The first file storage detects an updated file or a directory of the file system when the file system is updated in accordance with a request from a client; aggregates, collectively into a difference aggregation object, a plurality of pieces of difference data and difference data update information of detected files or directories; and transfers the difference aggregation object to the second file storage. The second file storage receives the difference aggregation object, and applies each part of the difference data to an object in the object storage in accordance with the difference data update information of the difference aggregation object.

The computer system according to the present invention makes it possible to reduce the amount of data transfer between each site and a data center. In addition, it is possible to reduce increases of management data and in the number of sessions of file storage apparatuses at sites.

### BRIEF DESCRIPTION OF THE DRAWINGS

FIG. 1 is a figure for explaining one example of the overview of the present embodiment;

FIG. 2 illustrates one example of a configuration diagram of a computer system according to a first embodiment;

FIG. 3 is a configuration diagram of an Edge file storage 100;

FIG. 4 is a configuration diagram of a Core file storage 200;

FIG. 5 is a configuration diagram of an object storage 300;

FIG. 6 illustrates one example of an operation log 500;

FIG. 7 is one example of a flowchart of a file/directory creation process 1000;

FIG. 8 is one example of a flowchart of a file updating process 2000;

FIG. 9 is a flowchart of a file migration process 3000;

FIG. 10 is a flowchart of a single-file transferring process 4000;

FIG. 11 is one example of a flowchart of an aggregated-file transferring process 5000;

FIG. 12 is one example of a flowchart of a directory migration process 6000;

FIG. 13 is a flowchart of a difference applying process 7000;

FIG. 14 is a flowchart of a file read process 8000;

FIG. 15 is a flowchart of a difference applying process 9000 for the time of a reference request;

FIG. 16 is one example of the configuration diagram of the computer system according to a second embodiment; and

FIG. 17 is a configuration diagram of a Core storage.

### DESCRIPTION OF THE PREFERRED EMBODIMENTS

In the following, embodiments are explained by referring to the drawings.

Note that although various types of information are explained by using the expression of an “aaa table” in some cases in the following explanation, the various types of information may be expressed in data structures other than tables. The various types of information expressed as “aaa tables” can be referred to as “aaa information” in order to indicate that they do not depend on data structures. In addition, in a case where a program or software is explained as performing processes, this is interpreted as meaning that the program or software is actually executed by a processor or the like.

Although expressions such as an “identifiers,” a “name” or an “ID” are used for identification information when the content of each piece of information is explained, these are interchangeable. Instead of at least one of them, many types of identification information may be used.

In addition, although processes are explained as being performed by a “program” in some cases in the following explanation, the processes may be explained as being performed by a processor because the program performs specified processes by being executed by the processor, which is a processing section, while using a storage resource (e.g. a memory) and/or a communication interface device (e.g. a communication port) as appropriate. Conversely, processes explained as being performed by a processor can be interpreted such that the processes are performed by execution of one or more programs. Processors are typically microprocessors like central processing units (CPUs), but may include a hardware circuit that executes some of processes (e.g. encoding/decoding, compression/decompression).

In addition, in the following explanation, reference characters are used in a case where elements of the same type are explained while they are not distinguished from each other, and identifiers (e.g. at least either numbers or reference characters) allocated to elements of the same type are used in some cases instead of the reference characters of the elements in a case where the elements are explained while they are distinguished from each other.

### First Embodiment

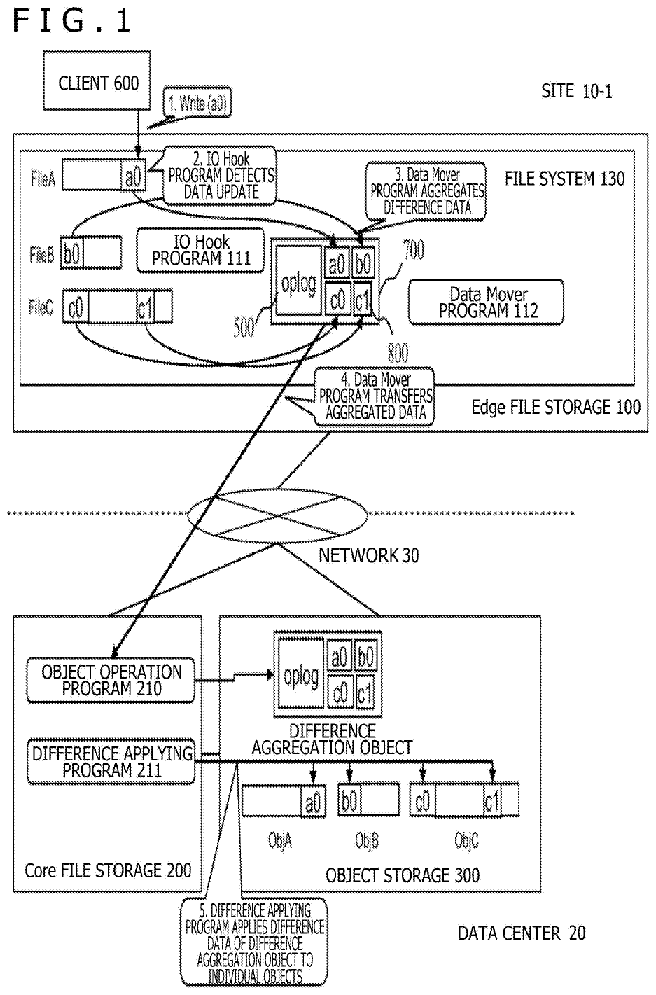

FIG. 1 is a figure for explaining one example of the overview of a first embodiment.

A computer system according to the first embodiment includes: an Edge file storage 100 that is one example of a file storage apparatus at a site 10-1; a client 600 connected to the Edge file storage 100; a Core file storage 200 (simply referred to as a Core in some cases) that is one example of a file storage apparatus at a data center 20 connected with the Edge file storage 100 via a network 30; and an object storage 300 that is one example of an object storage apparatus.

The Edge file storage 100 provides a file sharing service to the client 600, and has a file system 130. The Edge file storage 100 can execute operations on a file and a directory that are elements in the file system 130.

The Edge file storage 100 has an IO Hook program 111 and a Data Mover program 112, and operates in cooperation with the Core file storage 200 to realize the file sharing service. The IO Hook program 111 forms a detecting unit that detects operations on a file and a directory stored in the file system 130. The Data Mover program 112 forms a transfer section that transfers the file and the directory detected by the IO Hook program 111 to the Core file storage 200. Purposes of the transfer include creation of backups and archives.

The Core file storage 200 includes an object operation program 210 and a difference applying program 211. The object operation program 210 receives an object request from the Edge file storage 100, and stores, in the object storage 300, the file and the directory transferred as an object.

On the basis of the object request received from the Edge file storage 100, the object storage 300 stores the file or the directory that has been transferred to the object storage 300 as an object from the Core file storage 200.

In the first embodiment, the Edge file storage 100 aggregates difference data 800 stored in the file system 130, and difference data update information (oplog 500) thereof into one difference aggregation object 700, and transfers the difference aggregation object 700 to the Core file storage 200.

A specific example of the data transfer is explained.

(1) The client 600 performs an operation on the file system 130. The content of this operation is, for example, a “data update” of a file FileA in the file system 130 of the Edge file storage 100 that is a target of the operation. Here, in this illustrated example, data a0 in FileA is updated.

(2) Next, the IO Hook program 111 detects the data update of FileA as an operation on FileA. The detected information is stored as update information in metadata of FileA, another file, a database or the like.

(3) The Data Mover program 112 executes a migration process. The migration process is a process of transferring a file and a directory stored in the file system 130 of the Edge file storage 100 to the Core file storage 200. The migration process maybe performed in a case where a predetermined condition is satisfied. For example, the migration process may be performed regularly or irregularly, or maybe executed when the client 600 performs an operation on the file system 130. In the migration process, the Data Mover program 112 refers to the update information of the file system 130 detected by the IO Hook program 111, and aggregates the difference data 800.

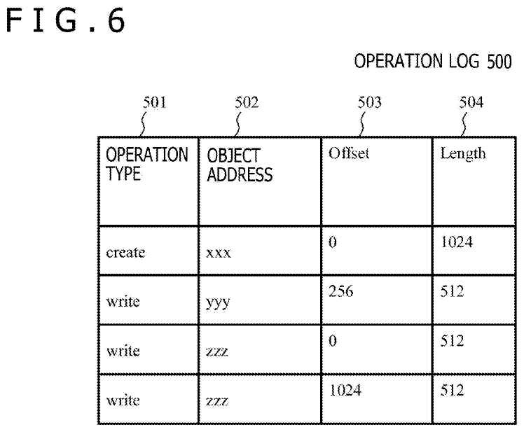

FIG. 1 illustrates an example in which the data a0 of FileA, data b0 of FileB and data c0 and c1 of FileC are aggregated. In addition to the difference data 800, the difference data update information is stored as the operation log 500 in the difference aggregation object 700. The operation log 500 includes operation contents, operation targets, object addresses of the operation targets, Offset and Length (see FIG. 6).

(4) The Data Mover program 112 transfers the difference data 800 and the operation log 500 aggregated at (3) described above, as the one difference aggregation object 700 to the Core file storage 200.

(5) The object operation program 210 in the Core file storage 200 receives the difference aggregation object 700 transferred from the Edge file storage 100, and stores the difference aggregation object 700 in the object storage 300.

(6) The difference applying program 211 in the Core file storage 200 executes a difference applying process. In the difference applying process, the difference aggregation object 700 is acquired, operation targets are recognized from the operation log 500 stored in the difference aggregation object 700, and the difference data 800 is applied to individual objects in the object storage 300. The difference applying process may be performed in a case where a predetermined condition is satisfied. For example, the difference applying process may be performed regularly or irregularly, or may be executed when an Edge file storage 100 performs an operation on the Core file storage 200.

By the process, the difference data stored in the file system 130 of the Edge file storage 100 is aggregated into the one difference aggregation object 700, and the one difference aggregation object 700 is transferred to the Core file storage 200. Thereby, the network transfer amount of the network 30 can be reduced.

Terms are explained below.

The “Difference data” indicates data itself input from the client 600 and stored in the file system 130. In FIG. 1, the difference data includes a0, b0, c0 and c1.

The “Difference data update information” is information that indicates which file, and which portion of the file are updated. Difference data update information may be stored in metadata of each updated file. The Difference data update information may be stored in a file other than an updated file. The Difference data update information may be stored in a database that manages difference data update information. The Difference data update information includes operation contents, operation targets, object addresses of the operation targets, Offset and Length.

The “difference aggregation object 700” is an object formed by aggregating one or more pieces of difference data and difference data update information thereof.

The “operation log 500” indicates difference data update information in the difference aggregation object.

“File states” are management information that indicates the states of files stored in the file system 130 of the Edge file storage 100. Each file state indicates one of three states, Dirty, Cached and Stubbed.

“File portion states” (or file data states or offset states) are management information that indicates the state of each offset of file data stored in the file system 130 of the Edge file storage 100. Each file portion state indicates one of three states, Dirty, Cached and Stubbed, for a file portion, that is, an offset of file data.

The state of Dirty indicates a state in which a file or an offset of file data is not applied at the data center 20.

The state of Cached indicates a state in which a file or an offset of file data is applied at the data center 20, and additionally the file data is stored in the file system 130 of the Edge file storage 100.

The state of Stubbed indicates a state in which a file or an offset of file data is applied at the data center 20, and additionally the file data is not stored in the file system 130 of the Edge file storage 100.

The storage location of a file state and a file portion state may be metadata of each file, may be a file other than the file, or may be a database that manages file states and file portion states.

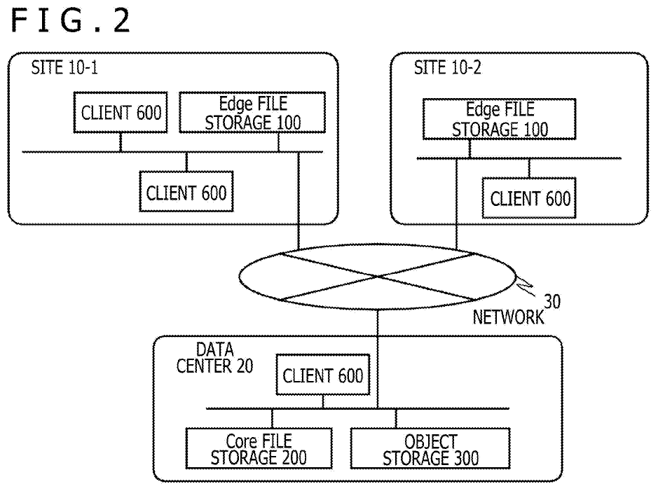

FIG. 2 is one example of a configuration diagram of the computer system according to the first embodiment.

The computer system has sites 10-1 and 10-2, the data center 20, and the network 30 connecting them with each other. One or more clients 600, and one or more Edge file storages 100 are arranged at each of the sites 10-1 and 10-2. The data center 20 has one or more clients 600, one or more Core file storages 200 and one or more object storages 300.

Clients 600 and Edge file storages 100 at each site 10-1 and 10-2 are connected to each other by a network such as an intra-site local area network (LAN), for example. The clients 600 use file sharing services provided by the Edge file storages 100 by using file sharing protocols such as a network file system (NFS) or a common internet file system (CIFS).

The clients 600, the Core file storages 200 and the object storages 300 at the data center 20 are connected to each other by a network such as an intra-site local area network (LAN).

The network 30 connecting the sites to each other is a wide area network (WAN) or the like, and, for example, each Edge file storage 100 accesses Core file storages 200 by using a protocol such as a hypertext transfer protocol (HTTP).

Note that although in the example illustrated and explained in the first embodiment, the computer system has the two sites 10-1 and 10-2, there may be any number of sites in the computer system.

Note that the types of the networks are not limited to the networks described above, but various networks can be used.

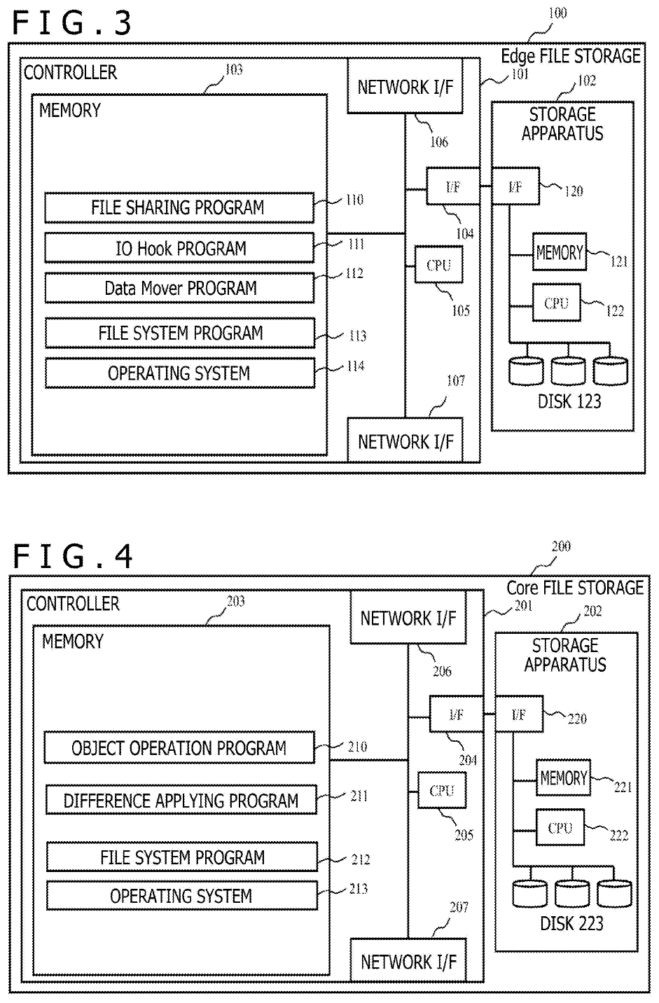

FIG. 3 is a configuration diagram of an Edge file storage 100.

The Edge file storage 100 has a controller 101 and a storage apparatus 102. The controller 101 has a memory 103, a CPU 105, network interfaces (I/Fs) 106 and 107 and an interface 104. These are interconnected to each other by a communication path such as a bus. The CPU 105 executes programs stored in the memory 103. The network interface 106 is an interface that communicates with a client 600 via an intra-site network. The network interface 107 is an interface that communicates with the data center 20 via the network 30. The interface 104 is an interface connected to an interface 120 in order to bidirectionally communicate with the storage apparatus 102.

The memory 103 stores programs and information for controlling the Edge file storage 100. Specifically, for example, the memory 103 stores a file sharing program 110, the IO Hook program 111, the Data Mover program 112, a file system program 113 and an operating system (OS) 114. Note that each program and piece of information stored in the memory 103 may be stored in the storage apparatus 102. In this case, these are read out by the CPU 105 to the memory 103, and executed.

The file sharing program 110 is a program that provides an interface between the Edge file storage 100 and clients 600 by using a file sharing protocol. The IO Hook program 111 is a program that detects operations on a file and a directory stored in a file system 130 via the file sharing program 110. The Data Mover program 112 is a program for transferring the directory and the file detected by the IO Hook program 111 to a Core file storage 200. The file system program 113 is a program that controls the file system 130.

The storage apparatus 102 has a memory 121, a CPU 122 and the interface 120. These are interconnected to each other by a communication path such as a bus. The interface 120 is an interface used for connection with the controller 101. The memory 121 and disks 123 store programs and data. On the basis of an instruction from the controller 101, the CPU 122 executes a program in the memory 121. The storage apparatus 102 may provide, to the controller 101, a block-format storage function such as a fibre channel storage area network (FC-SAN).

FIG. 4 is a configuration diagram of a Core file storage 200.

The Core file storage 200 has a controller 201 and a storage apparatus 202. The controller 201 has a memory 203, a CPU 205, network interfaces (I/F) 206 and 207 and an interface 204. These are interconnected to each other by a communication path such as a bus. The CPU 205 executes programs stored in the memory 203. The network interface 206 is an interface that communicates with an Edge file storage 100 via the network 30. The network interface 207 is an interface that communicates with an object storage 300 via a network in the data center 20. The interface 204 is an interface connected to an interface 220 in order to bidirectionally communicate with the storage apparatus 202.

The memory 203 stores programs and information for controlling the Core file storage 200. Specifically, for example, the memory 203 stores the object operation program 210, the difference applying program 211, a file system program 212 and an operating system (OS) 213. Note that each program and piece of information stored in the memory 203 maybe stored in the storage apparatus 202. In this case, these are read out by the CPU 205 to the memory 203, and executed.

The object operation program 210 is a program that provides an interface between an Edge file storage 100 and an object storage 300 by using the HTTP protocol, for example. The file system program 212 is a program that controls a file system stored in the storage apparatus 202.

The storage apparatus 202 has a memory 221, a CPU 222 and the interface 220. These are interconnected to each other by a communication path such as a bus. The interface 220 is an interface used for connection with the controller 201. The memory 221 and disks 223 store programs and data. On the basis of an instruction from the controller 201, the CPU 222 executes a program in the memory 221. The storage apparatus 202 may provide, to the controller 201, a block-format storage function such as an FC-SAN.

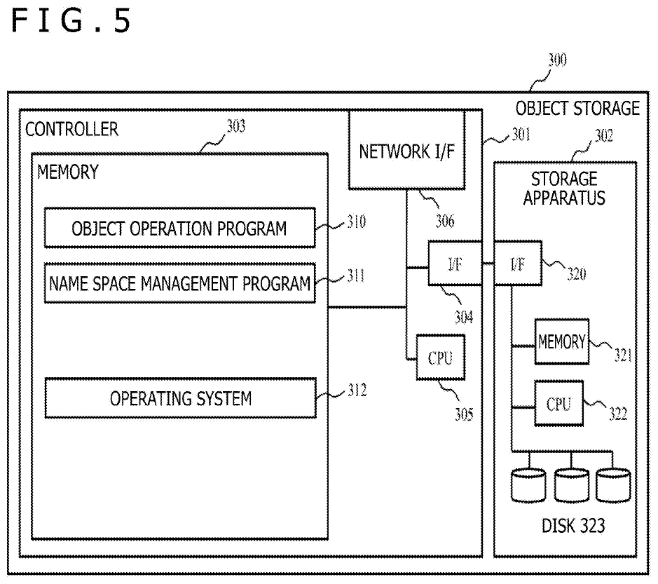

FIG. 5 is a configuration diagram of an object storage 300. The object storage 300 has a controller 301 and a storage apparatus 302. The controller 301 has a memory 303, a CPU 305, a network interface 306 and an interface 304. These are interconnected to each other by a communication path such as a bus. The CPU 305 executes programs stored in the memory 303. The network interface 306 is an interface that communicates with a Core file storage 200 via a network in the data center 20. The interface 304 is an interface connected to an interface 320 in order to communicate with the storage apparatus 302.

The memory 303 stores programs and information for controlling the object storage 300. Specifically, for example, the memory 303 stores an object operation program 310, a name space management program 311 and an operating system (OS) 312. Note that each program and piece of information stored in the memory 303 may be stored in the storage apparatus 302. In this case, these are read out by the CPU 305 to the memory 303, and executed.

The object operation program 310 is a program that processes a request from a Core file storage 200 (e.g. a PUT request or a GET request). The name space management program 311 is a program that creates/manages name spaces.

The storage apparatus 302 has a memory 321, a CPU 322, disks 323 and the interface 320. These are interconnected to each other by a communication path such as a bus. The interface 320 is an interface used for connection with the controller 301. The memory 321 and the disks 323 store programs and data. On the basis of an instruction from the controller 301, the CPU 322 executes a program in the memory 321. The storage apparatus 302 may provide, to the controller 301, a block-format storage function such as an FC-SAN.

FIG. 6 illustrates one example of the operation log 500. Operation types 501, object addresses 502, Offsets 503 and Lengths 504 are recorded in the operation log 500. The operation types 501 indicate, for example, file creation, file update, metadata update and the like.

In the following, flowcharts of processes according to the first embodiment are illustrated.

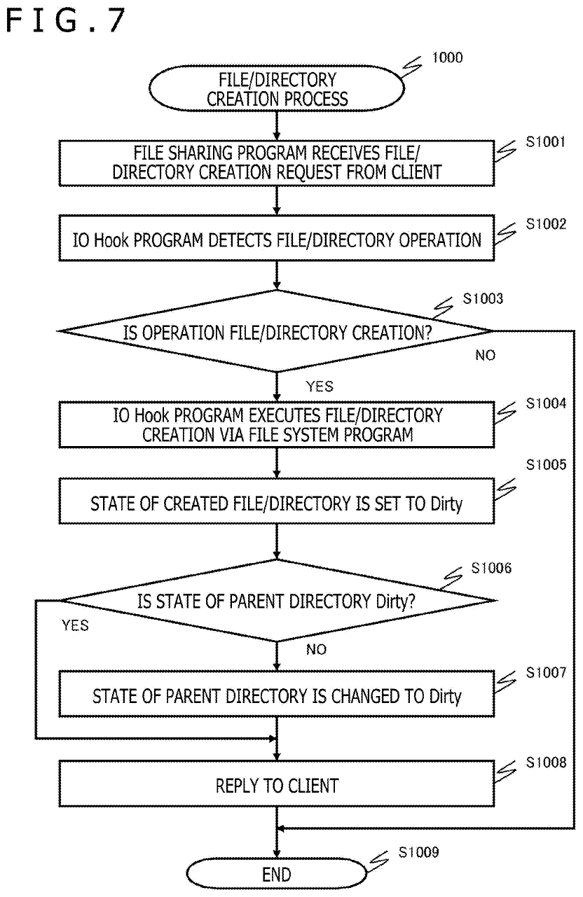

FIG. 7 is one example of a flowchart of a file/directory creation process 1000. The file/directory creation process 1000 is performed by a CPU 105 of a controller 101 in each Edge file storage 100 by executing the file sharing program 110 and the IO Hook program 111.

The file sharing program 110 receives a file/directory creation request from a client 600 (S1001).

The IO Hook program 111 detects a file/directory operation received by the file sharing program 110 (S1002).

The IO Hook program 111 determines whether or not the operation detected at S1002 is file/directory creation (S1003).

In a case where the operation detected at S1002 is not file/directory creation (S1003: No), the file/directory creation process 1000 is ended (S1009).

On the other hand, in a case where the operation detected at S1002 is file/directory creation (S1003: Yes), the IO Hook program 111 requests the file system program 113 to perform file/directory creation, and the file system program 113 creates a file/directory in a file system 130. At this step, in accordance with the file type of a target file of the operation detected at S1002, the IO Hook program 111 requests the file system program 113 to perform file creation in a case where the file type is normal and to perform directory creation in a case where the file type is directory. On the basis of the requested file type, the file system program 113 creates a file/directory (S1004).

The IO Hook program 111 sets the state of the created file/directory to Dirty (S1005). The method of managing the state of a file/directory may be any method such as a method of storing the state in metadata of the file, a method of storing the state in a management file other than the created file/directory or a method of storing the state in a database.

The IO Hook program 111 determines the state of a parent directory of the created file/directory (S1006).

In a case where the state of the parent directory of the created file/directory is not Dirty (Step S1006: No), the IO Hook program 111 changes the state of the parent directory to Dirty (S1007).

On the other hand, in a case where the state of the parent directory of the created file/directory is Dirty (Step S1006: Yes), the IO Hook program 111 proceeds to S1008.

The file sharing program 110 replies to the client 600 with a notification of completion of the file/directory creation (S1008), and ends the file/directory creation process 1000 (S1009).

Although the file/directory creation and the setting of the state of a file/directory are executed at two steps of Steps S1004 and S1005, these may be executed at one step.

By the file/directory creation process 1000, the state of a created file/directory and the state of a parent directory are set to Dirty, and the file/directory updated after the previous migration process can be identified.

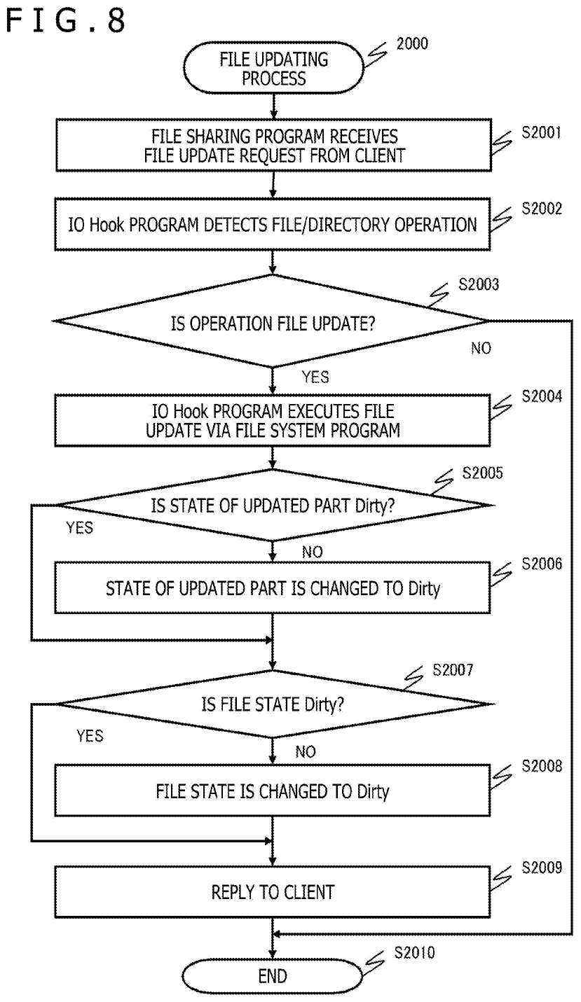

FIG. 8 is one example of a flowchart of a file updating process 2000. The file updating process 2000 is performed by a CPU 105 of a controller 101 in each Edge file storage 100 by executing the file sharing program 110 and the IO Hook program 111.

The file sharing program 110 receives a file update request from a client 600 (S2001). File updates specifically include updates and addition of file data by a Write operation, decompression and truncation of file data by a Truncate operation, updates of metadata such as changes of owners/groups or access rights of files or updates and addition of extended attributes.

The IO Hook program 111 detects a file/directory operation received by the file sharing program 110 (S2002).

The IO Hook program 111 determines whether or not the operation detected at S1002 is a file update (S2003).

In a case where the operation detected at S2002 is not a file update (S2003: No), the file updating process 2000 is ended (S2010).

On the other hand, in a case where the operation detected at S2002 is a file update (S2003: Yes), the IO Hook program 111 requests the file system program 113 to perform a file update, and the file system program 113 updates the file in a file system 130 (S2004). At this step, in accordance with the operation of the file update detected at S2002, the IO Hook program 111 requests the file system program 113 to perform a Write operation or a Truncate operation in a case where the operation is a data update, and to perform a metadata update operation in a case where the operation is a metadata update. The file system program 113 updates the file on the basis of the requested file operation.

The IO Hook program 111 checks the file portion state of an updated part in the updated file, and determines whether or not the file portion state is Dirty (S2005).

In a case where the state of the updated part in the file data of the updated file is not Dirty (Step S2005: No), the IO Hook program 111 changes the file portion state of the updated part to Dirty (S2006). The method of managing the state of each area in file data (part of a file) may be any method such as a method of storing the state as update information in metadata of the file, a method of storing the state as update information in a management file other than an operation target file or a method of storing the state as update information in a database. At this step, in a case where the states of some updated parts are not Dirty and the states of other updated parts are Dirty, only the states of the portions whose states are not Dirty are changed to Dirty.

On the other hand, in a case where the file state of the updated part in the file data of the updated file is Dirty (Step S2005: Yes), the IO Hook program 111 proceeds to S2007.

The IO Hook program 111 checks the state of the updated file, and determines whether or not the state is Dirty (S2007).

In a case where the state of the updated file is not Dirty (Step S2007: No), the IO Hook program 111 changes the file state to Dirty (S2008).

On the other hand, in a case where the state of the updated file is Dirty (Step S2007: Yes), the IO Hook program 111 proceeds to S2009.

The file sharing program 110 replies to the client 600 with a notification of completion of the file update (S2009), and ends the file updating process 2000 (S2010).

By the file updating process 2000, the states of the area in file data of an updated file and the file are set to Dirty, and the file data and file updated after the previous migration process can be identified.

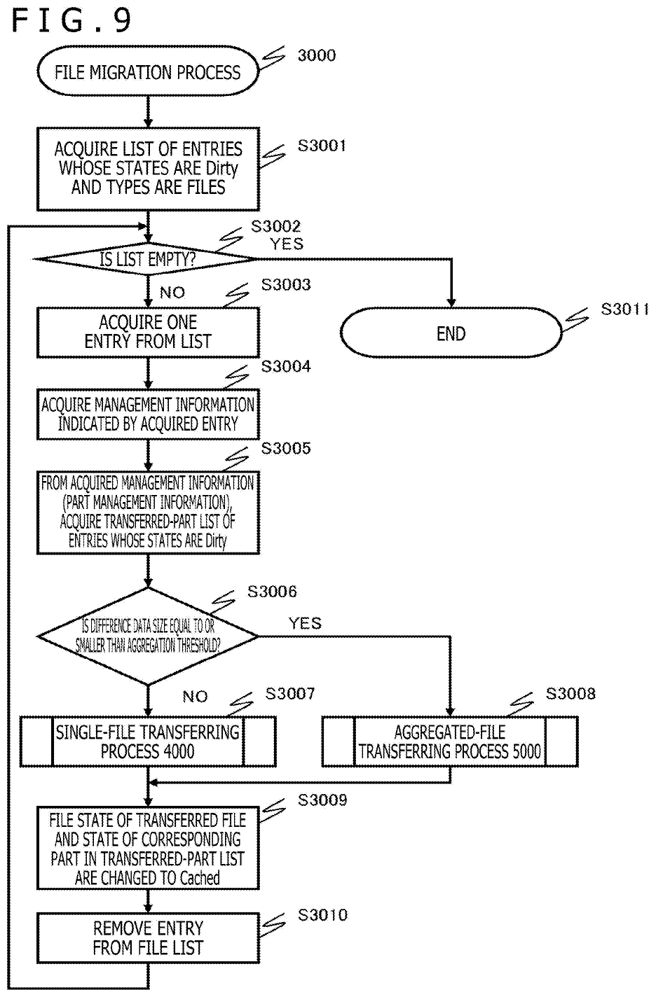

FIG. 9 is one example of a flowchart of a file migration process 3000. The file migration process 3000 is performed by a CPU 105 of a controller 101 in each Edge file storage 100 by executing the Data Mover program 112. Note that the file migration process 3000 may be performed in a case where a predetermined condition is satisfied. For example, the file migration process 3000 may be performed regularly or irregularly, or may be executed when a client 600 performs an operation on a file system 130. In addition, the file migration process 3000 and a directory migration process may be executed sequentially or may be executed simultaneously.

From among files/directories stored in the file system 130, the Data Mover program 112 acquires files/directories that satisfy a condition in which the file states are Dirty and the file types are file, and creates a list of the files/directories (S3001). The method of acquiring files satisfying a condition at this step may be any method such as a method of crawling a file system 130, a method of extracting files from an operation log in which operations of the file system is recorded, or a method of extracting files from a database that manages file system operation information.

The Data Mover program 112 determines whether or not the list created at S3001 is empty (Step S3002).

In a case where the list is empty (Step S3002: Yes), the file migration process 3000 is ended (S3011).

On the other hand, in a case where the list is not empty (Step S3002: No), the Data Mover program 112 acquires one of entries in the list that correspond to files whose states are Dirty (S3003).

The Data Mover program 112 acquires difference data update information of the entry as management information (S3004). The storage location of the management information (update information) may be an extended attribute of the file, a management file or a database.

The Data Mover program 112 acquires a transferred-part list of entries (difference data) whose states of file data are Dirty from the management information acquired at S3004 (S3005). That is, in a case where there are a plurality of offsets indicating updated portions of files and pieces of part management information such as Dirty information, the Data Mover program 112 acquires a list of a plurality of updated portions (transferred-part list). This transferred-part list includes information {Offset, Length and Object address} of the oplog 500 like the one illustrated in FIG. 6.

The Data Mover program 112 determines whether or not the difference data size of the transferred-part list acquired at S3005 is equal to or smaller than an aggregation threshold (S3006). The aggregation threshold is a threshold for determining whether to transfer each piece of the difference data as a single file to a Core 200 or to transfer the difference data to the Core after aggregating the differenced data. In a case where the difference data size is greater than the aggregation threshold, each piece of the difference data is transferred as a single file, and in a case where the difference data is equal to or smaller than the aggregation threshold, the difference data is transferred as an aggregated file.

In a case where the difference data size is equal to or smaller than the aggregation threshold, the Data Mover program 112 executes an aggregated-file transferring process 5000 (S3008).

On the other hand, in a case where the difference data size is greater than the aggregation threshold, the Data Mover program 112 executes a single-file transferring process 4000 (S3007).

The Data Mover program 112 changes the file state of the file transferred to the Core and the state of the file data of the transferred part to Cached (S3009).

The Data Mover program 112 removes the entry of the transferred file from the list created at S3001, and proceeds to S3002 (S3010).

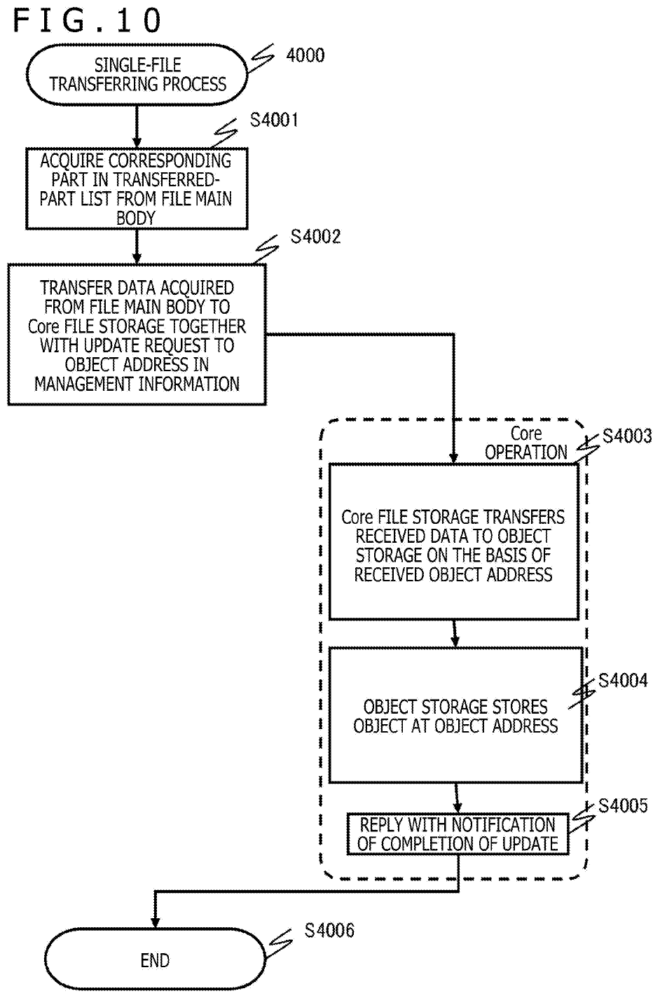

FIG. 10 is one example of a flowchart of the single-file transferring process 4000. The single-file transferring process 4000 is a process of transferring a file created at and a file updated at the Edge file storage 100 as a single file to the Core, and is executed at S3007 in the file migration process 3000.

The Data Mover program 112 acquires a part recorded in the transferred-part list as difference data from the file main body via the file system program 113 (S4001).

The Data Mover program 112 acquires an object address from the management information, and makes an update request for the object address. At this time, the file data acquired at S4001 is transferred (S4002).

The object operation program 210 in the Core file storage 200 receives the object update request from the Edge file storage 100, and transfers the received data to an object storage 300 on the basis of the object address specified by the received request (S4003).

The object storage 300 receives a request from the Core file storage 200, and stores the receive data in the specified object address (S4004).

The Core file storage 200 sends a reply to the Edge file storage 100 (S4005).

Although FIG. 10 illustrates an example in which the Core file storage 200 transfers, to the object storage 300, the object received from the Edge file storage 100, the object may be stored in the storage apparatus 202 of the Edge file storage 100, and a reply may be sent. In addition, the object may be stored in the object storage 300 asynchronously with a reply to the request received from the Edge file storage 100.

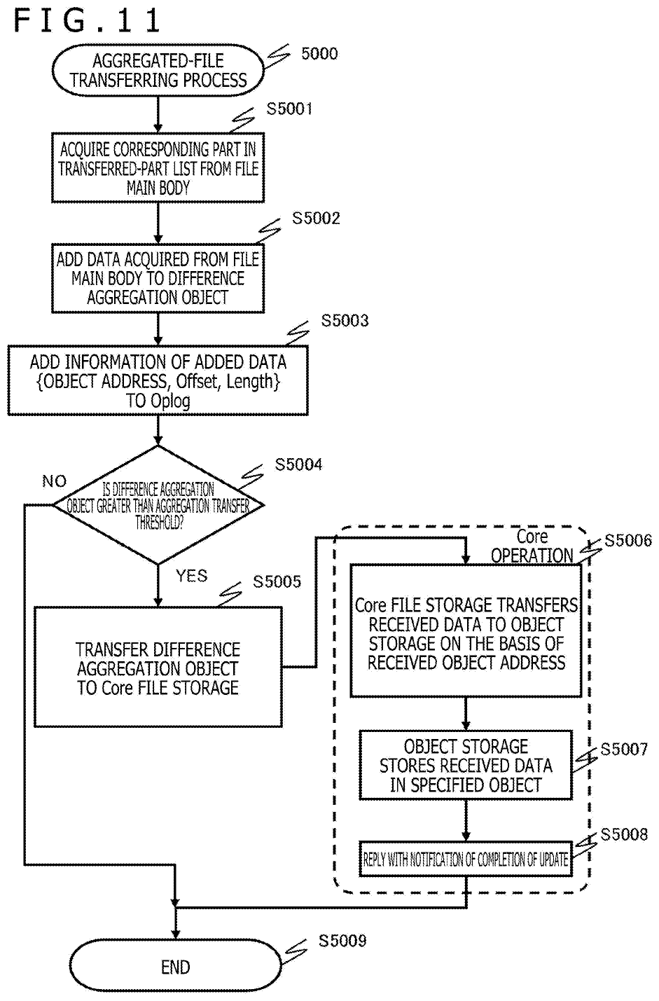

FIG. 11 is one example of a flowchart of the aggregated-file transferring process 5000. The aggregated-file transferring process 5000 is a process of aggregating and transferring files created at and files updated at the Edge file storage 100 to the Core, and is executed at S3008 in the file migration process 3000.

The Data Mover program 112 acquires a part recorded in the transferred-part list as difference data from the file main body via the file system program 113 (S5001).

The Data Mover program 112 adds the data (update information) acquired from the file main body to a difference aggregation object (S5002). The difference aggregation object is temporary data that retains aggregated data of a plurality of files transferred in the aggregated-file transferring process 5000, and is temporarily stored in a memory 103 or a storage apparatus 102. There may be one difference aggregation object or may be a plurality of difference aggregation objects. For example, there may be a difference aggregation object for each directory, for each name such as a file name, a filename extension or an object address, or for each file size.

The Data Mover program 112 adds, to the Oplog 500 of the difference aggregation object, information {object address, Offset, Length} of the data added at S5002 (S5003).

The Data Mover program 112 determines whether or not the difference aggregation object exceeds an aggregation transfer threshold (S5004). The aggregation transfer threshold is used for determining whether or not the difference aggregation object satisfies a transfer condition. There may be one or more aggregation transfer thresholds. For example, the aggregation transfer thresholds may relate to the total data sizes of difference aggregation objects, the numbers of pieces of data or elapsed time from creation, or a combination thereof.

In a case where the difference aggregation object does not exceed the aggregation transfer threshold (S5004: No), the aggregated-file transferring process 5000 is ended (S5009).

On the other hand, in a case where the aggregated data exceeds the aggregation transfer threshold (S5004: Yes), the Data Mover program 112 decides an object address of the difference aggregation object, and transfers the difference aggregation object in order to make an update request for the object address (S5005). The method of deciding the object address of the difference aggregation object may be a method of using a predetermined address, a method of determining the object address by the Edge file storage 100 inquiring of the Core file storage 200 or may be a method of determining the object address by the Edge file storage 100 or the Core file storage 200 inquiring of an external server.

The object operation program 210 in the Core file storage 200 receives the update request from the Edge file storage 100, and transfers the received data for the object address to an object storage 300 on the basis of the object address (included in Oplog) specified by the received request (S5006).

The object storage 300 receives a request from the Core file storage 200, and stores the receive data in the specified object address (S5007).

The Core file storage 200 sends a reply to the Edge file storage 100 (S5008).

Although FIG. 11 illustrates an example in which the Core file storage 200 transfers, to the object storage 300, the object received from the Edge file storage 100, the object may be stored in the storage apparatus 202 of the Edge file storage 100, and a reply may be sent. In addition, the object may be stored in the object storage 300 asynchronously with a reply to the request received from the Edge file storage 100.

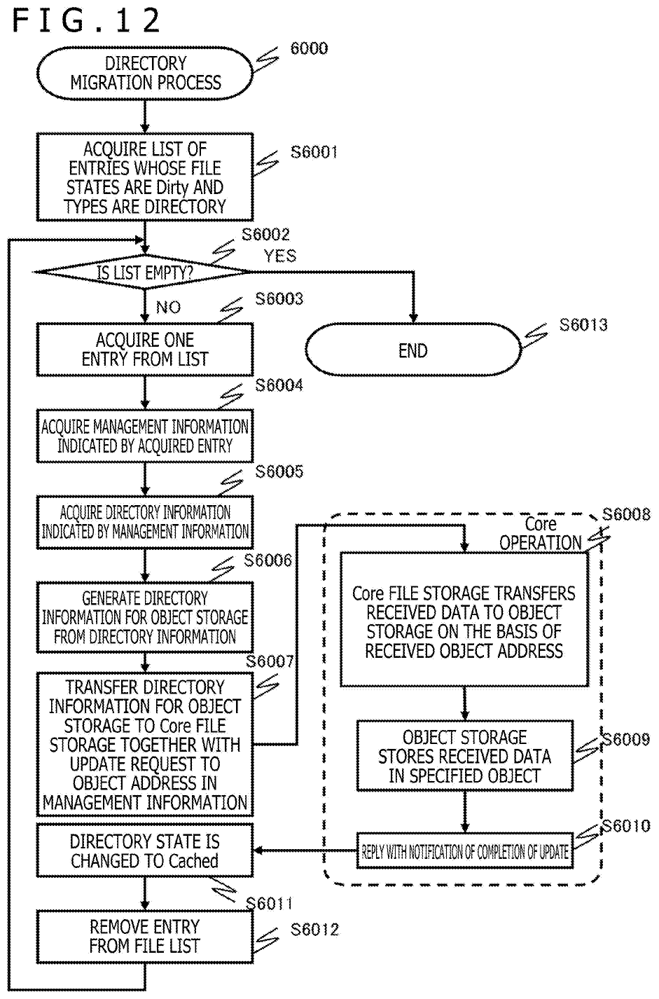

FIG. 12 is one example of a flowchart of a directory migration process 6000. The directory migration process 6000 is performed by a CPU 105 of a controller 101 in each Edge file storage 100 by executing the Data Mover program 112. Note that the directory migration process 6000 may be performed in a case where a predetermined condition is satisfied. For example, the directory migration process 6000 may be performed regularly or irregularly, or may be executed when a client 600 performs an operation on a file system 130. In addition, the file migration process 3000 and the directory migration process may be executed sequentially or may be executed simultaneously. Note that core operations 56008 to S6010 are performed by a CPU 205 of a Core file storage 200 by executing a program stored in a memory 203 thereof .

From among files/directories stored in the file system 130, the Data Mover program 112 acquires files/directories that satisfy a condition in which the file states are Dirty and the file types are directory, and creates a list of the files/directories (S6001). The method of acquiring files satisfying a condition at this step may be any method such as a method of crawling the file system 130, a method of extracting files from an operation log in which operations of the file system is recorded, or a method of extracting files from a database that manages file system operation information.

The Data Mover program 112 determines whether or not the list created at S6001 is empty (Step S6002).

In a case where the list is empty (Step S6002: Yes), the directory migration process 6000 is ended (S6013).

On the other hand, in a case where the list is not empty (Step S6002: No), the Data Mover program 112 acquires one of entries in the list that correspond to directories whose states are Dirty (S6003).

The Data Mover program 112 acquires management information including a directory name and a file name of the entry (S6004). The storage location of the management information may be an extended attribute of the file, a management file or a database.

The Data Mover program 112 acquires directory information from the management information such as a directory name or a file name acquired at S6004 (S6005). The directory information includes metadata of the directory, and directory entry information of the directory. The directory entry information includes names and object addresses of files stored therein and sub-directories thereof.

From the directory information acquired at S6005, the Data Mover program 112 generates directory information for an object storage (S6006).

The Data Mover program 112 acquires an object address from the management information, and makes an update request for the object address. At this time, the directory information for the object storage generated at S6006 is transferred (S6007).

The Core file storage transfers the received data to the object storage on the basis of the received object address. That is, the object operation program 210 in the Core file storage 200 receives the update request from the Edge file storage 100, converts the object address specified by the received request into an object address of the object storage 300, and transfers the data received for the object address to the object storage 300 (S6008).

The object storage 300 receives a request from the Core file storage 200, and stores the receive data in the specified object address (S6009).

The Core file storage 200 sends a reply to the Edge file storage 100 (S6010).

The Data Mover program 112 changes the file state of the directory transferred to the Core to Cached (S6011).

The Data Mover program 112 removes the entry of the transferred directory from the list created at S6001, and proceeds to S6002 (S6012).

Although FIG. 12 illustrates an example in which the Core file storage 200 transfers, to the object storage 300, the object received from the Edge file storage 100, the object may be stored in the storage apparatus 202 of the Edge file storage 100, and a reply may be sent to the Edge file storage 100. In addition, the object may be stored in the object storage 300 asynchronously with a reply to the request received from the Edge file storage 100.

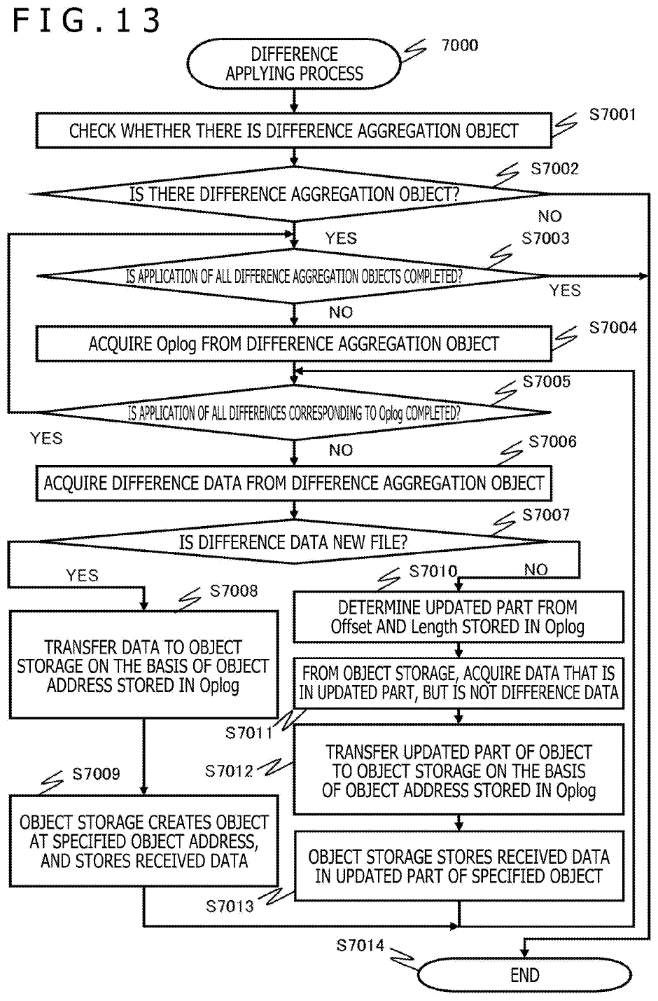

FIG. 13 is one example of a flowchart of a difference applying process 7000. The difference applying process 7000 is performed by a CPU 205 of a controller 201 in a Core file storage 200 by executing the difference applying program 211. Note that the difference applying process 7000 may be performed in a case where a predetermined condition is satisfied. For example, the difference applying process 7000 may be performed regularly or irregularly, or may be executed when an Edge file storage 100 performs an operation on the Core file storage 200.

The difference applying program 211 checks whether or not there is a difference aggregation object 700 (S7001). At this step, the presence of an object stored in an object storage 300 may be checked by using the object operation program 210, or the presence of an object stored in a storage apparatus 202 may be checked by using the file system program 212.

In a case where there are no difference aggregation objects (S7002: No), the difference applying program 211 ends the difference applying process 7000.

On the other hand, in a case where there are one or more difference aggregation objects (S7002: Yes), the difference applying program 211 determines whether application of all the difference aggregation objects is completed (S7003).

In a case where application of all the difference aggregation objects is completed (S7003: Yes), the difference applying program 211 ends the difference applying process 7000.

On the other hand, in a case where application of all the difference aggregation objects is not completed (S7003: No), the difference applying program 211 acquires one of unapplied difference aggregation objects, and acquires Oplog from the difference aggregation object (S7004). At this step, a difference aggregation object stored in the object storage 300 may be acquired by using the object operation program 210, or an object stored in the storage apparatus 202 may be acquired by using the file system program 212.

The difference applying program 211 determines whether application of all the pieces of difference data corresponding to Oplog to individual objects is completed (S7005). In a case where the application is completed (S7005: Yes), the difference applying program 211 proceeds to S7003. On the other hand, in a case where the application is not completed, the difference applying program 211 proceeds to S7006.

The difference applying program 211 acquires one or more pieces of difference data from the difference aggregation object (S7006).

The difference applying program 211 determines whether or not the difference data acquired at S7006 is a new file (S7007). At this step, the determination may be made on the basis of an operation type stored in Oplog, or the determination may be made on the basis of whether or not an object address stored in Oplog is included in the object storage 300. In a case where the difference data is a new file (S7007: Yes), the difference applying program 211 proceeds to S7008.

On the other hand, in a case where the difference data is not a new file (S7007: No), the difference applying program 211 proceeds to S7010.

In a case where the difference data is determined as a new file at S7007, on the basis of an object address stored in Oplog, the difference applying program 211 transfers the data acquired at S7006 to an object storage (S7008).

The object storage 300 receives a request from the Core file storage 200, creates a new object at the specified object address, stores the received data, and proceeds to S7005 (S7009).

In a case where the difference data is determined as not a new file at S7007, from Offset and Length stored in Oplog, the difference applying program 211 decides an updated part that is an updated portion of an object stored in the object storage 300 (S7010). This step depends on the minimum size of updated parts in the object storage 300, and in a case where the difference data is smaller than the minimum size of the updated parts, the updated part is set to the minimum size.

The difference applying program 211 acquires, from the object storage 300, data that is part of the updated part but is not the difference data (Step S7011). This is for merging the difference data and the data other than the difference data, and forming the updated part.

On the basis of the object address stored in Oplog, the difference applying program 211 transfers the updated part of the object to the object storage 300 (S7012).

The object storage 300 receives a request from the Core file storage 200, stores the received data in the updated part at the specified object address, and proceeds to S7005 (S7013).

In FIG. 13, difference aggregation objects for which application of all the differences is completed may be removed from the object storage 300.

By this process, difference data transferred as difference aggregation objects from the Edge file storage 100 can be applied to individual objects in the object storage 300.

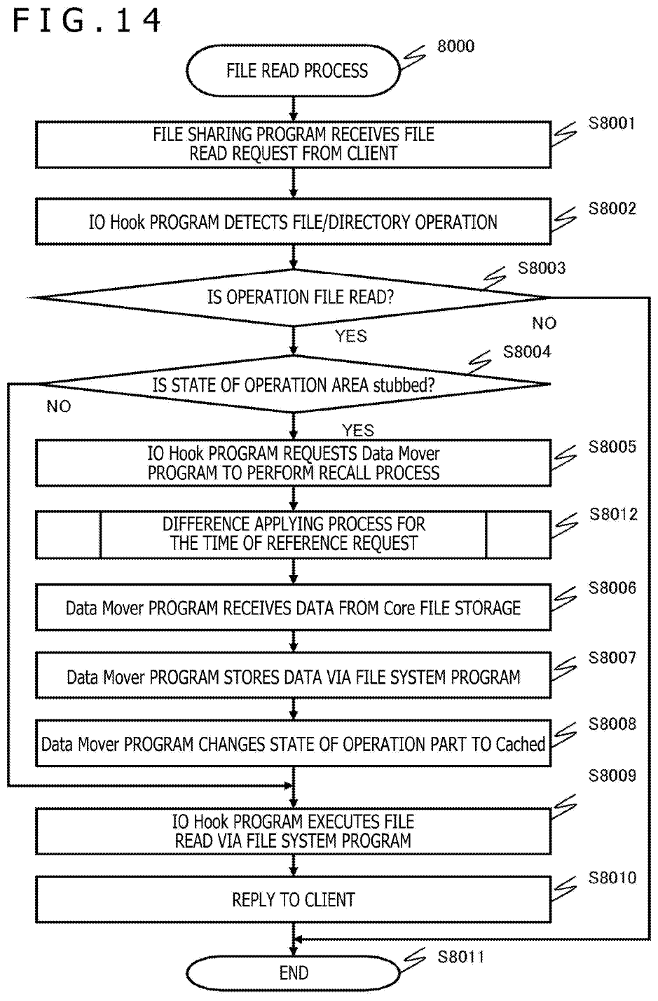

FIG. 14 is one example of a flowchart of a file read process 8000. The file read process 8000 is performed by a CPU 105 of a controller 101 in each Edge file storage 100 by executing the file sharing program 110, the IO Hook program 111 and the Data Mover program 112.

The file sharing program 110 receives a file read request from a client 600 (S8001).

The IO Hook program 111 detects a file/directory operation received by the file sharing program 110 (S8002).

The IO Hook program 111 determines whether or not the operation detected at S8002 is file read (S8003).

In a case where the operation detected at S8002 is not file read (S8003: No), the file read process 8000 is ended (S8011).

On the other hand, in a case where the operation detected at S8002 is file read (S8003: Yes), the IO Hook program 111 determines whether or not the state of an operation area is Stubbed (S8004).

In a case where the state of the operation area is Stubbed (S8004: Yes), the IO Hook program 111 proceeds to S8005. On the other hand, in a case where the state of the operation area is not Stubbed (S8004: No), the IO Hook program 111 proceeds to S8009. In a case where the state of at least a part of the operation area is Stubbed, the IO Hook program 111 determines that the state of the operation area is Stubbed at S8004.

In a case where the state of the operation area is Stubbed, the IO Hook program 111 requests the Data Mover program 112 to perform a recall process, and the Data Mover program 112 requests data from a Core file storage 200 (S8005). The recall process is a process of acquiring data from a Core because the data is not stored in a file system 130 of the Edge file storage 100.

The Core file storage 200 executes a difference applying process 9000 for the time of a reference request (S8012).

The Data Mover program 112 receives data from the Core file storage 200 (S8006).

The Data Mover program 112 stores the data in the file system 130 via the file system program 113 (S8007).

The Data Mover program 112 changes the state of the operation part from Stubbed to Cached (S8008).

The IO Hook program 111 executes file read via the file system program 113 (S8009).

The IO Hook program 111 sends a reply to the client 600 (S8010), and ends the file read process 8000 (S8011).

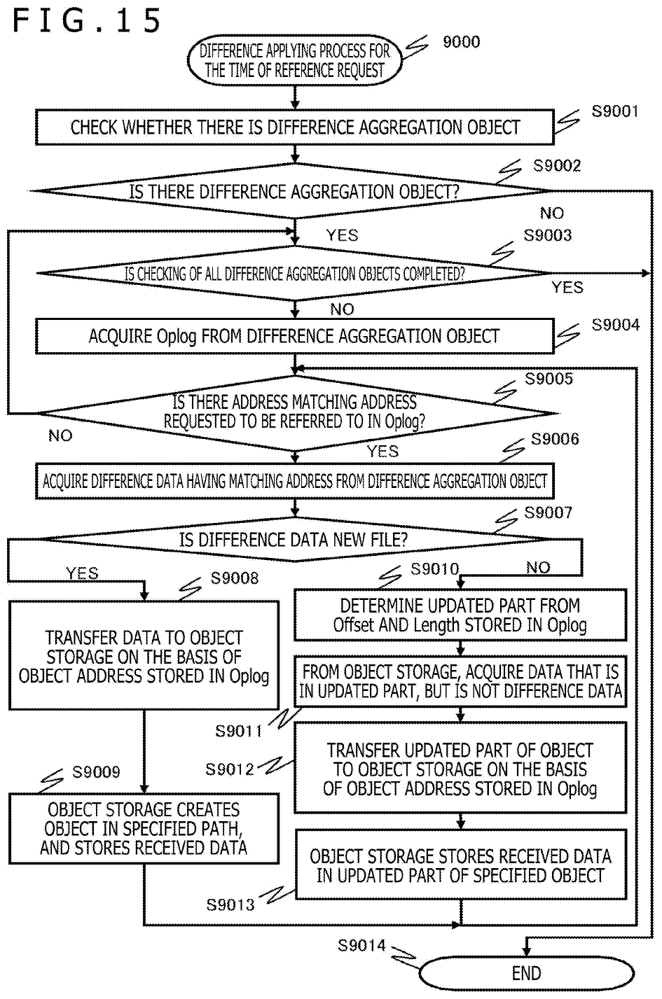

FIG. 15 is one example of a flowchart of the difference applying process 9000 for the time of a reference request. The difference applying process 9000 for the time of a reference request is performed by a CPU 205 of a controller 201 in a Core file storage 200 by executing the difference applying program 211. The difference applying process 9000 for the time of a reference request is executed at S8012 in the file read process.

The difference applying program 211 checks whether or not there is a difference aggregation object (S9001). At this step, the presence of an object stored in an object storage 300 may be checked by using the object operation program 210, or the presence of an object stored in a storage apparatus 202 may be checked by using the file system program 212.

In a case where there are no difference aggregation objects (S9002: No), the difference applying program 211 ends the difference applying process 9000. On the other hand, in a case where there are one or more difference aggregation objects (S9002: Yes), the difference applying program 211 determines whether checking of all the difference aggregation objects is completed (S9003).

In a case where checking of all the difference aggregation objects is completed (S9003: Yes), the difference applying program 211 ends the difference applying process 9000.

On the other hand, in a case where checking of all the difference aggregation objects is not completed (S9003: No), the difference applying program 211 acquires Oplog from unchecked difference aggregation objects (S9004). At this step, a difference aggregation object stored in the object storage 300 may be acquired by using the object operation program 210, or an object stored in the storage apparatus 202 may be acquired by using the file system program 212.

The difference applying program 211 performs a search to determine whether there is an object address in Oplog that matches an object address requested to refer to (S9005). In a case where there are no object addresses in Oplog that match the object address requested to refer to (S9005: No), the difference applying program 211 proceeds to S9003. On the other hand, in a case where there is an object address in Oplog that matches the object address requested to refer to, the difference applying program 211 proceeds to S9006.

From the difference aggregation object, the difference applying program 211 acquires difference data having the matching object address (S9006).

The difference applying program 211 determines whether or not the difference data acquired at S9006 is a new file (S9007). At this step, the determination may be made on the basis of an operation type stored in Oplog, or the determination may be made on the basis of whether or not an object address stored in Oplog is included in the object storage 300. In a case where the difference data is a new file (S9007: Yes), the difference applying program 211 proceeds to S9008. On the other hand, in a case where the difference data is not a new file (S9007: No), the difference applying program 211 proceeds to S9010.

In a case where the difference data is determined as a new file at S9007, on the basis of an object address stored in Oplog, the data is transferred to an object storage. That is, the difference applying program 211 converts the object address stored in Oplog into an object address in the object storage 300, and transfers the data acquired at S9006 to the object storage (S9008).

The object storage 300 receives a request from the Core file storage 200, creates a new object at the specified object address, stores the received data, and proceeds to S9005 (S9009).

In a case where the difference data is determined as not a new file at S9007, from Offset and Length stored in Oplog, the difference applying program 211 decides an updated part that is an updated portion of an object stored in the object storage 300 (S9010). This step depends on the minimum size of updated parts in the object storage 300, and in a case where the difference data is smaller than the minimum size of the updated parts, the updated part is set to the minimum size.

The difference applying program 211 acquires, from the object storage 300, data that is part of the updated part but is not the difference data (Step S9011).

On the basis of the object address stored in Oplog, the difference applying program 211 transfers the data to the object storage. That is, the object address stored in Oplog is converted into an object address in the object storage 300, and the updated part of the object is transferred to the object storage 300 (S9012).

The object storage 300 receives a request from the Core file storage 200, stores the received data in the updated part at the specified object address, and proceeds to S9005 (S9013).

In FIG. 15, difference data to which differences are applied in accordance with reference requests may be recorded in advance, and the difference applying process may be skipped at the time of the next reference request. Thereby, it is possible to reduce processes of applying the same difference data multiple times.

In FIG. 15, only a difference at an object address matching an object address requested to refer to may be applied, and differences of the entire difference aggregation object may be applied. In addition, difference data for which application of all the differences is completed may be removed from the difference aggregation object, and the update information may be removed from Oplog.

By this process, difference data transferred as a difference aggregation object from an Edge file storage 100 can be applied to individual objects in an object storage 300 on demand at the time of reference requests from clients 600, and the latest data can be sent back to the clients 600.

### Second Embodiment

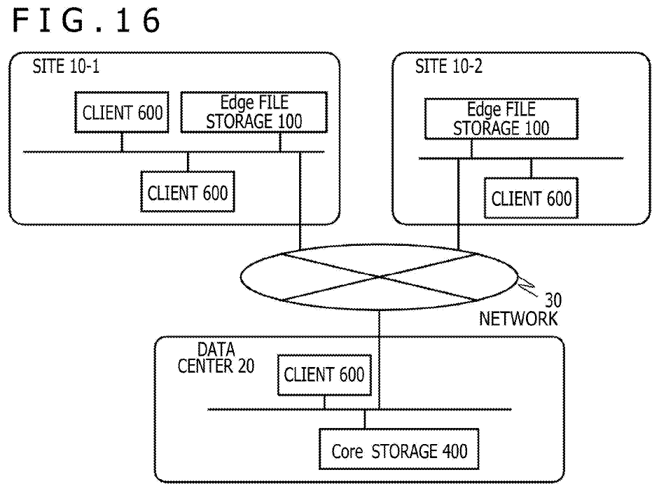

FIG. 16 is one example of the configuration diagram of the computer system according to a second embodiment. The second embodiment is different from the first embodiment in that a Core file storage 200 and an object storage 300 in the first embodiment are replaced by a Core storage 400.

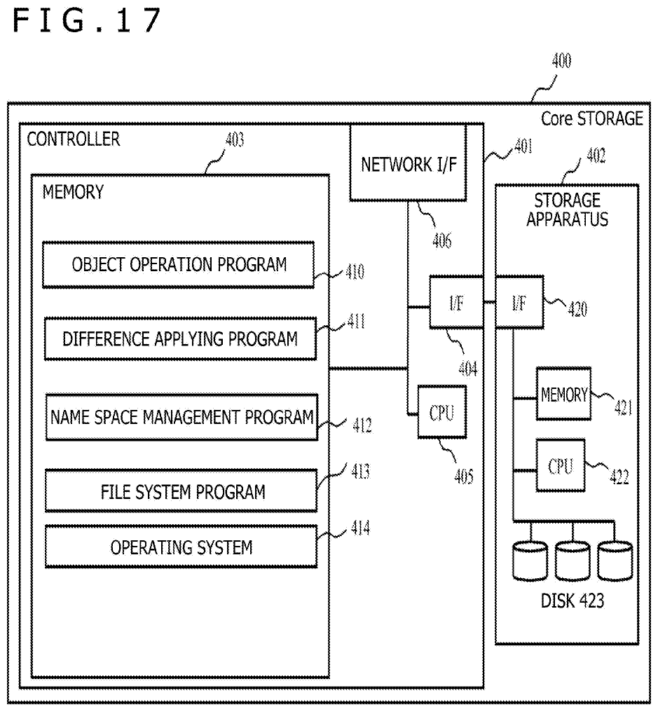

FIG. 17 illustrates a configuration example of the Core storage 400. The Core storage 400 has a controller 401 and a storage apparatus 402. The controller 401 has a memory 403, a CPU 405, a network interface (I/F) 406 and an interface 404. These are interconnected to each other by a communication path such as a bus. The CPU 405 executes programs stored in the memory 403. The network interface 406 is an interface that communicates with an Edge file storage 100 via the network 30. The interface 404 is an interface connected to an interface 420 in order to bidirectionally communicate with the storage apparatus 402.

The memory 403 stores programs and information for controlling the Core storage 400. Specifically, for example, the memory 403 stores an object operation program 410, a difference applying program 411, a name space management program 412, a file system program 413 and an operating system (OS) 414. Note that each program and piece of information stored in the memory 403 may be stored in the storage apparatus 402. In this case, these are read out by the CPU 405 to the memory 403, and executed.

The storage apparatus 402 has a memory 421, a CPU 422 and the interface 420. These are interconnected to each other by a communication path such as a bus. The interface 420 is an interface used for connection with the controller 401. The memory 421 and disks 423 store programs and data. On the basis of an instruction from the controller 401, the CPU 422 executes a program in the memory 421. The storage apparatus 402 may provide, to the controller 401, a block-format storage function such as an FC-SAN.

Several embodiments have been explained thus far, but it is needless to say that the present invention is not limited to these embodiments, but can be changed variously within a scope not deviating from the gist of the present invention.

What is claimed is:

1. A computer system comprising:
a first file storage that provides a file sharing service to a client, and has a file system;
a second file storage that is connected with the first file storage via a network, and receives an object request from the first file storage; and
an object storage that stores a file or a directory that has been transferred to the object storage as an object from the second file storage, on a basis of an object request received from the first file storage, wherein
the first file storage
detects an update of a file or a directory of the file system from the client,
aggregates, collectively into a difference aggregation object, a plurality of parts of difference data and difference data update information of detected files or directories, and
transfers the difference aggregation object to the second file storage, and
the second file storage
receives the difference aggregation object, and
applies each part of the difference data to an object in the object storage in accordance with the difference data update information of the difference aggregation object.

2. The computer system according to claim 1, wherein
the first file storage is an Edge file storage, and
the second file storage is a Core file storage.

3. The computer system according to claim 2, wherein
the difference aggregation object aggregated at the Edge file storage has: a plurality of pieces of the difference data; and operation logs for managing a relationship between a type, an object address, an offset and a length of an operation on the file system, the operation logs each corresponding to one piece of the difference data as update information of the plurality of pieces of the difference data.

4. The computer system according to claim 1, wherein
the first file storage
executes a single-file transferring process in a case where the difference data in the difference aggregation object exceeds a predetermined value, and
executes an aggregated-file transferring process of aggregating and transferring a plurality of pieces of difference data and difference data update information in a case where the difference data in the difference aggregation object is equal to or smaller than a predetermined value.

5. The computer system according to claim 4, wherein
transfer of the difference aggregation object to the second file storage by the first file storage, and application of the difference data to the object in the object storage by the second file storage are executed asynchronously.

6. The computer system according to claim 4, wherein
transfer of the difference aggregation object to the second file storage by the first file storage, and application of the difference data to the object in the object storage by the second file storage are executed synchronously.

7. The computer system according to claim 4, wherein
application of the difference data to the object in the object storage by the second file storage is executed at a time of a reference request from the client to the file system.

8. A file storage included in a computer system including: a first file storage that provides a file sharing service to a client and has a file system; a second file storage that is connected with the first file storage via a network and receives an object request from the first file storage; and an object storage that stores a file or a directory that has been transferred to the object storage as an object from the second file storage, on a basis of the object request received from the first file storage, wherein
the first file storage includes
a detecting section that detects an update of a file or a directory of the file system from the client, and
a transfer section that aggregates, collectively into a difference aggregation object, a plurality of pieces of difference data and difference data update information of detected files or directories, and transfers the difference aggregation object to the second file storage.

9. The file storage according to claim 8, wherein
the transfer section
executes a single-file transferring process in a case where the difference data in the difference aggregation object exceeds a predetermined value, and
executes an aggregated-file transferring process of aggregating and transferring a plurality of pieces of difference data and difference data update information in a case where the difference data in the difference aggregation object is equal to or smaller than a predetermined value.

10. A data transfer method of a computer system including: a first file storage that provides a file sharing service to a client and has a file system; a second file storage that is connected with the first file storage via a network and receives an object request from the first file storage; and an object storage that stores a file or a directory that has been transferred to the object storage as an object from the second file storage, on a basis of the object request received from the first file storage, the data transfer method comprising:
by the first file storage,
detecting an update of a file or a directory of the file system from the client;
aggregating, collectively into a difference aggregation object, a plurality of pieces of difference data and difference data update information of detected files or directories; and
transferring the difference aggregation object to the second file storage, and
by the second file storage,
receiving the difference aggregation object;
transferring the difference aggregation object to the object storage; and
applying each piece of the difference data to an object in the object storage in accordance with the difference data update information of the difference aggregation object.
